(19) United States
(12) Patent Application Publication
(10) Pub. No.: US 2024/0062930 A1
(43) Pub. Date: Feb. 22, 2024

(54) Electric cable comprising a thermoplastic insulating layer with improved electrical and mechanical performance

(71) Applicant: NEXANS, Courbevoie (FR)

(72) Inventors: Gabriele PEREGO, MILAN (IT); Christelle MAZEL, RUY (FR); Paul Charles BARUSTA, LYON (FR)

(21) Appl. No.: 18/267,775

(22) PCT Filed: Dec. 17, 2021
(86) PCT No.: PCT/FR2021/052391

§ 371 Date: Jun. 15, 2023

(30) Foreign Application Priority Data
Dec. 18, 2020 (FR) FR2013676

(51) Int. Cl. H01B 3/44

(52) U.S. Cl. CPC H01B 3/441; H01B 3/442; H01B 3/447

(57) ABSTRACT

The invention relates to a cable comprising at least one electrically insulating layer obtained from a polymer composition comprising at least one homophasic propylene polymer, and at least one homophasic ethylene polymer having an elastic modulus greater than 300 MPa, said propylene and ethylene polymers being in specific proportions.

The invention relates to a cable comprising at least one electrically insulating layer obtained from a polymer composition comprising at least one homophase propylene polymer, and at least one homophase ethylene polymer having an elastic modulus greater than 300 MPa, said propylene and ethylene polymers being in specific proportions.

The invention applies typically but not exclusively to electric cables intended for power transmission, in particular to low-voltage power cables (in particular less than or equal to 6 kV), whether direct-current or alternating-current, in the fields of aerial, underwater, and terrestrial transport of electricity, or in aeronautics.

The invention applies in particular to electric cables with improved thermomechanical and electrical properties.

A low-voltage power transmission cable preferably comprises, from the interior outwards:
an elongated electrically conducting element, in particular made of copper or aluminum;
an electrically insulating layer surrounding said elongated electrically conducting element; and
optionally an electrically insulating protective sheath surrounding said electrically insulating layer.

From U.S. Pat. No. 6,162,548, an electric cable is known comprising at least one elongated electrically conducting element and at least one layer comprising a noncrosslinked polymer material including a homopolymer or copolymer of crystalline propylene and an ethylene elastomer and an alpha olefin having from 3 to 12 carbon atoms. However, the thermomechanical and electrical properties are not optimized.

The aim of the present invention is accordingly to overcome the drawbacks of the techniques of the prior art by proposing an electric cable, in particular low-voltage, based on propylene polymer(s), said cable being able to function at temperatures above 70° C., and having improved thermomechanical properties, while guaranteeing good electrical properties.

This aim is achieved by the invention that will be described hereunder.

The invention relates firstly to an electric cable comprising at least one elongated electrically conducting element and at least one electrically insulating layer obtained from a polymer composition, characterized in that the polymer composition comprises:
at least 50 wt % of a homophase propylene polymer relative to the total weight of polymers in said polymer composition,
at least one homophase ethylene polymer having an elastic modulus strictly greater than 300 MPa,
said propylene polymer representing a proportion by weight strictly greater than that of the homophase ethylene polymer, relative to the total weight of polymers of said polymer composition, and
the polymer composition comprising at most 10 wt % of a heterophase propylene polymer, relative to the total weight of polymers in said polymer composition.

The cable of the invention presents the advantage of being able to operate at temperatures above 70° C., and has improved thermomechanical properties, while guaranteeing good electrical properties.

### The Propylene Polymer

In the present invention, “homophase polymer” means any polymer having a single phase, or substantially homogeneous phase.

More particularly, a homophase polymer is not a heterophase polymer. As examples of heterophase polymers, mention may be made of the heterophase copolymers of propylene, such as for example those described in document WO2011/092533, namely: Adflex Q200F or Hifax CA 7441A, from the company Basell (LyondellBasell).

The heterophase polymer comprises at least two separate phases: one comprising a polymer matrix, and the other comprising particles or nodules dispersed in this polymer matrix, which may be for example an elastomeric phase. This type of polymer may be easily identifiable by techniques familiar to a person skilled in the art, such as for example by scanning electron microscopy (SEM). More particularly, with a magnification of ×10 000, said particles or nodules dispersed in said polymer matrix are typically observed, said particles having a number-average size ranging from 200 nm to 10 μm, and preferably between 500 nm and 1 μm.

A homophase polymer in particular does not comprise particles or nodules of this type dispersed in a polymer matrix. In fact, with analysis by SEM, a substantially homogeneous single phase can be observed. More particularly, at a magnification of ×10 000, a homogeneous polymer matrix comprising hardly any particles or nodules dispersed in said matrix is typically observed.

The homophase propylene polymer may be a propylene homopolymer or copolymer, and preferably a propylene copolymer.

As examples of homophase propylene copolymers, mention may be made of the copolymers of propylene and olefin, the olefin being in particular selected from ethylene and an α₁ olefin different than propylene.

The ethylene or α₁ olefin different than propylene of the homophase propylene copolymer preferably represents at most about 45 mol %, especially preferably at most about 35 mol %, more especially preferably at most about mol %, and more especially preferably at most about 10 mol %, relative to the total number of moles of homophase propylene copolymer.

The ethylene or α₁ olefin different than propylene of the homophase propylene copolymer may represent at least about 1 mol %, relative to the total number of moles of homophase propylene copolymer.

The molar percentage of ethylene or of α₁ olefin in the homophase propylene copolymer may be determined by nuclear magnetic resonance (NMR), for example by the method described in Masson et al., Int. J. Polymer Analysis & Characterization, 1996, Vol. 2, 379-393.

The α₁ olefin different than propylene may correspond to the formula CH₂═CH—R¹, in which R¹ is a linear or branched alkyl group having from 2 to 12 carbon atoms, in particular selected from the following olefins: 1-butene, 1-pentene, 4-methyl-1-pentene, 1-hexene, 1-octene, 1-decene, 1-dodecene, and a mixture thereof.

The copolymers of propylene and ethylene are preferred as homophase propylene copolymers.

The homophase propylene copolymer is advantageously a random copolymer of propylene.

As examples of homophase random propylene copolymer, mention may be made of that marketed by the company Borealis under the reference Bormed® RB 845 MO, that marketed by the company Total Petrochemicals under the reference PPR 3221, that marketed by the company Sabic under the reference PP 620P, or that marketed by the company Repsol Isplen under the reference RC530S2E.

The homophase propylene homopolymer preferably has an elastic modulus from about 1250 to 1600 MPa.

The homophase propylene copolymer preferably has an elastic modulus from about 600 to 1200 MPa, and especially preferably from about 800 to 1100 MPa.

In the present invention, the elastic modulus or Young's modulus of a polymer (also known as “tensile modulus”) is familiar to a person skilled in the art, and may easily be determined according to standard ISO 527-1, -2 (2012). Standard ISO 527 comprises a first part, “ISO 527-1”, and a second part, “ISO 527-2” specifying the test conditions relative to the general principles of the first part of standard ISO 527.

The homophase propylene polymer may have a melting point above about 130° C., especially preferably above about 135° C., and more especially preferably from about 140 to 175° C.

The homophase propylene polymer may have an enthalpy of fusion from about 20 to 100 J/g.

The homophase propylene homopolymer preferably has an enthalpy of fusion from about 80 to 90 J/g.

The homophase propylene copolymer preferably has an enthalpy of fusion from about 40 to 90 J/g, and especially preferably from 50 to 85 J/g.

The homophase propylene polymer may have a melt flow index from 0.5 to 3.5 g/10 min, preferably from 1.0 to 2.8 g/10 min, and especially preferably from 1.2 to 2.5 g/10 min; in particular determined at about 230° C. with a load of about 2.16 kg according to standard ASTM D1238-00, or standard ISO 1133.

The homophase propylene polymer may have a density from about 0.81 to 0.92 g/cm³, preferably from 0.85 to 0.91 g/cm³, and especially preferably from 0.87 to 0.91 g/cm³; in particular determined according to standard ISO 1183A (at a temperature of 23° C.)

The homophase propylene polymer may represent from about 55 to 90 wt %, and especially preferably from about 60 to 80 wt %, relative to the total weight of polymers in the polymer composition.

### The Homophase Ethylene Polymer

The polymer composition further comprises a homophase ethylene polymer.

The homophase ethylene polymer is an ethylene homopolymer or copolymer, and preferably an ethylene copolymer.

The homophase ethylene polymer preferably comprises at least about 80 mol % of ethylene, especially preferably at least about 90 mol % of ethylene, and more especially preferably at least about 95 mol % of ethylene, relative to the total number of moles of the ethylene polymer.

The ethylene polymer has an elastic modulus of at least 300 MPa, preferably an elastic modulus of at least 325 MPa, and especially preferably of at least 350 MPa. Thus, this makes it possible to obtain improved thermomechanical properties while optimizing the cost of production.

The ethylene polymer preferably has an elastic modulus of at most 600 MPa, and especially preferably at most 500 MPa.

According to a preferred embodiment of the invention, the ethylene polymer is a low-density polyethylene, a linear low-density polyethylene, a medium-density polyethylene, or a high-density polyethylene; in particular according to standard ISO 1183A (at a temperature of 23° C.)

In the present invention, the expression “low density” signifies having a density from about 0.91 to 0.925 g/cm³, said density being measured according to standard ISO 1183A (at a temperature of 23° C.)

In the present invention, the expression “medium density” signifies having a density from about 0.926 to 0.940 g/cm³, said density being measured according to standard ISO 1183A (at a temperature of 23° C.)

In the present invention, the expression “high density” signifies having a density from 0.941 to 0.965 g/cm³, said density being measured according to standard ISO 1183A (at a temperature of 23° C.)

According to an especially preferred embodiment of the invention, the ethylene polymer has a density of at most 0.936 g/cm³, especially preferably at most 0.930 g/cm³, and more especially preferably at most 0.925 g/cm³; said density being measured in particular according to standard ISO 1183A (at a temperature of 23° C.). These densities make it possible to reduce the hardness or stiffness of the layer, and thus obtain better flexibility.

According to this embodiment, the ethylene polymer may be a low-density polyethylene, a linear low-density polyethylene, or a medium-density polyethylene, and especially preferably a linear low-density polyethylene.

As examples of linear low-density polyethylene, mention may be made of that marketed by the company Exxon under the reference LL 1004YB, that marketed by the company Sabic under the reference 318B, or that marketed by the company Versalis under the reference Flexirene CL 10.

The homophase ethylene polymer may represent from about to 45 wt %, and especially preferably from about 20 to 40 wt %, relative to the total weight of polymers in the polymer composition.

The proportion by weight (i.e. amount by weight) of the homophase propylene polymer is strictly greater than the proportion by weight (i.e. amount by weight) of the homophase ethylene polymer, relative to the total weight of polymers in the polymer composition. This has the advantage of producing a layer having good mechanical properties, in particular in terms of breaking strength and elongation at break, at high temperatures (e.g. temperatures greater than or equal to 90° C.)

The homophase ethylene polymer may have a melt flow index from 0.5 to 5 g/10 min, and preferably from 1 to 3 g/10 min; in particular determined at about 230° C. with a load of about 2.16 kg according to standard ASTM D1238-00, or standard ISO 1133.

### The Heterophase Propylene Polymer

The polymer composition may comprise at least one heterophase (or heterophasic) propylene polymer.

The polymer composition comprises at most about 10 wt % of a heterophase propylene polymer, preferably from about 0 to 8 wt %, and especially preferably from about 3 to 6 wt % of a heterophase propylene polymer relative to the total weight of polymers in the polymer composition. These maximum proportions of heterophase propylene polymer make it possible to reduce the cost of production of the layer, which is a great advantage in low-voltage applications. In addition, its presence makes it possible to obtain better compatibility between the homophase propylene polymer and the homophase ethylene polymer, and thus further optimize the thermomechanical properties of the layer.

The heterophase propylene polymer is a heterophase propylene copolymer.

It may comprise a thermoplastic phase of the propylene type and a thermoplastic elastomer phase of the type of copolymer of ethylene and an α₂ olefin.

The α₂ olefin of the thermoplastic elastomer phase of the heterophase propylene copolymer may be propylene.

The thermoplastic elastomer phase of the heterophase propylene copolymer may represent at least about 20 wt %, and preferably at least about 45 wt %, relative to the total weight of the heterophase propylene copolymer.

The heterophase propylene copolymer preferably has an elastic modulus from about 50 to 1200 MPa, and especially preferably: either an elastic modulus from about 50 to 550 MPa, and more especially preferably from about 50 to 300 MPa; or an elastic modulus from about 600 to 1200 MPa, and more especially preferably from about 800 to 1200 MPa.

As examples of heterophase propylene copolymer, mention may be made of the heterophase propylene copolymers marketed by the company LyondellBasell under the references Adflex® Q 200 F, Moplen EP® 2967, Hifax CA 10A, or Hifax CA 12A.

The heterophase propylene polymer may have a melting point greater than about 140° C., especially preferably greater than about 145° C., and more especially preferably from about 150 to 175° C.

The heterophase propylene polymer may have an enthalpy of fusion from about 20 to 100 J/g, and preferably from about 20 to 50 J/g.

The heterophase propylene polymer may have a melt flow index from 0.5 to 5 g/10 min, and preferably from about 0.6 to 2 g/10 min; in particular determined at about 230° C. with a load of about 2.16 kg according to standard ASTM D1238-00, or standard ISO 1133.

The heterophase propylene polymer may have a density from about 0.81 to 0.92 g/cm³, preferably from 0.85 to 0.91 g/cm³, and especially preferably from 0.87 to 0.91 g/cm³; in particular determined according to standard ISO 1183A (at a temperature of 23° C.)

### The Polymer Composition

The composition may further comprise other polymers different than the aforementioned polymers.

According to a preferred embodiment of the invention, the homophase propylene polymer, the homophase ethylene polymer, and the heterophase propylene polymer when it is present, represent at least about 80 wt %, preferably at least about 85 wt %, and especially preferably from about 90 to 100 wt %, relative to the total weight of polymers in the polymer composition.

When the polymer composition comprises other polymers different than the aforementioned polymers, such as for example one or more propylene and/or ethylene polymers (homophase and/or heterophase), the proportion by weight (i.e. amount by weight) of homophase propylene polymers is preferably strictly greater than the proportion by weight (i.e. amount by weight) of homophase ethylene polymers, relative to the total weight of polymers in the polymer composition.

The polymers of the polymer composition preferably together form a heterophase thermoplastic material (i.e. comprising several phases). The presence of several phases generally results from the mixing of two different polyolefins, such as a mixture of different propylene polymers and/or a mixture of a propylene polymer and an ethylene polymer.

The polymer composition of the electrically insulating layer of the invention is a thermoplastic polymer composition. Therefore it is not crosslinkable.

In particular, the polymer composition does not comprise crosslinking agents, coupling agents of the silane type, peroxides and/or additives that allow crosslinking. In fact, such agents degrade the polypropylene-based thermoplastic polymer material.

Similarly, the polymer composition preferably does not comprise olefin polymers grafted with crosslinkable functions, such as for example vinylsilane olefin polymers.

The polymer composition is preferably recyclable.

The polymer composition of the cable of the invention may comprise at most about 20 wt %, preferably at most about 10 wt %, and especially preferably at most about wt %, of polar polymer(s) relative to the total weight of polymer(s) in the polymer composition.

In the present invention, the expression “polar” signifies that the polymer of this type comprises one or more polar functions, such as for example acetate, acrylate, hydroxyl, nitrile, carboxyl, carbonyl, ether, and ester groups, or any other groups of polar character well known in the prior art such as in particular the silane groups. For example, a polar polymer is a polymer selected from the copolymers of ethylene of the type of copolymer of ethylene and vinyl acetate (EVA), copolymer of ethylene and butyl acrylate (EBA), copolymer of ethylene and ethyl acrylate (EEA), copolymer of ethylene and methyl acrylate (EMA), and copolymer of ethylene and acrylic acid (EAA).

The polymer composition preferably does not comprise polar polymer(s). In fact, the latter may lower the resistance to thermal aging of the electrically insulating layer of the invention.

The polymer composition may further comprise one or more additives.

The additives may be selected from agents favorable to application, such as lubricants, compatibilizing agents, coupling agents, antioxidants, anti-UV agents, anti-copper agents, anti-water treeing agents, pigments, and a mixture thereof.

The polymer composition preferably comprises at least one antioxidant and/or at least one anti-copper agent (also called metal deactivator).

The polymer composition may typically comprise from about 0.01 to 5 wt %, and preferably from about 0.1 to 2 wt % of additives, relative to the total weight of the polymer composition.

The antioxidants make it possible to protect the polymer composition from the thermal stresses generated during the steps of manufacture of the cable or operation of the cable.

The antioxidants are preferably selected from hindered phenols, thioesters, sulfur-based antioxidants, phosphorus-based antioxidants, antioxidants of the amine type, and a mixture thereof.

As examples of hindered phenols, mention may be made of 1,2-bis(3,5-di-tert-butyl-4-hydroxyhydrocinnamoyl) hydrazine (Irganox® MD 1024), pentaerythritol tetrakis(3-(3,5-di-tert-butyl-4-hydroxyphenyl)propionate) (Irganox® 1010), octadecyl 3-(3,5-di-tert-butyl-4-hydroxyphenyl)propionate (Irganox® 1076), 1,3,5-trimethyl-2,4,6-tris(3,5-di-tert-butyl-4-hydroxybenzyl)benzene (Irganox® 1330), 4,6-bis(octylthiomethyl)-o-cresol (Irgastab® KV10 or Irganox® 1520), 2,2′-thiobis(6-tert-butyl-4-methylphenol) (Irganox® 1081), 2,2′-thiodiethylene bis[3-(3,5-di-tert-butyl-4-hydroxyphenyl) propionate] (Irganox® 1035), tris(3,5-di-tert-butyl-4-hydroxybenzyl) isocyanurate (Irganox® 3114), 2,2′-oxamido-bis(ethyl-3(3,5-di-tert-butyl-4-hydroxyphenyl)propionate) (Naugard XL-1), or 2,2′-methylenebis(6-tert-butyl-4-methylphenol).

As examples of sulfur-based antioxidants, mention may be made of the thioethers such as didodecyl-3,3′-thiodipropionate (Irganox® PS800), distearyl thiodipropionate or dioctadecyl-3,3′-thiodipropionate (Irganox® PS802), bis[2-methyl-4-{3-n-alkyl (C₁₂ or C₁₄) thiopropionyloxy}-5-tert-butylphenyl]sulfide, thiobis-[2-tert-butyl-5-methyl-4,1-phenylene] bis [3-(dodecylthio)propionate], or 4,6-bis(octylthiomethyl)-o-cresol (Irganox® 1520 or Irgastab® KV10).

As examples of phosphorus-based antioxidants, mention may be made of tris(2,4-di-tert-butyl-phenyl)phosphite (Irgafos® 168) or bis(2,4-di-tert-butylphenyl)pentaerythritol diphosphite (Ultranox® 626).

As examples of antioxidants of the amine type, mention may be made of the phenylene diamines (e.g. paraphenylene diamines such as 1PPD or 6PPD), diphenylamine styrene, diphenylamines, 4-(1-methyl-1-phenylethyl)-N-[4-(1-methyl-1-phenylethyl)phenyl]aniline (Naugard 445), mercapto benzimidazoles, or polymerized 2,2,4-trimethyl-1,2 dihydroquinoline (TMQ).

As examples of mixtures of antioxidants usable according to the invention, mention may be made of Irganox B 225, which comprises an equimolar mixture of Irgafos 168 and Irganox 1010 as described above.

The metal deactivator may be selected from the azotized aromatic heterocycles, and the aromatic compounds comprising at least one —NH—C(═O)— function, and preferably from the aromatic compounds comprising at least one —NH—C(═O)— function. The presence of oxygen in the metal deactivator is important so as to be able to provide lasting immobilization of the metallic ions.

The metal deactivator is preferably different than a hindered amine. In other words, the metal deactivator preferably does not comprise one or more tetramethylpiperidine groups.

As examples of azotized aromatic heterocycles, mention may be made of the quinoline derivatives such as polymerized 2,2,4-trimethyl-1,2-dihydroquinolines (TMQ).

As examples of aromatic compounds comprising at least one —NH—C(═O)— function, mention may be made of those comprising two —NH—C(═O)— functions, preferably comprising two —NH—C(═O)— functions bound covalently, and more especially preferably comprising a divalent group —NH—C(═O)—C(═O)—NH— or —C(═O)—NH—NH—C(═O)—, such as 2,2′-oxamidobis-[ethyl-3-(3,5-di-tert-butyl-4-hydroxyphenyl) propionate] (Naugard XL-1), 2′,3-bis[[3-[3,5-di-tert-butyl-4-hydroxyphenyl]propionyl]] propionohydrazide or 1,2-bis(3,5-di-tert-butyl-4-hydroxyhydrocinnamoyl) hydrazine (Irganox® 1024 or Irganox® MD 1024), or oxalyl bis(benzylidenehydrazide) (OABH).

Certain metal deactivators are also antioxidants.

As the polymer composition is used in particular for low-voltage applications, it preferably does not comprise dielectric liquid, or in other words liquid selected from a mineral oil (e.g. naphthenic oil, paraffinic oil or aromatic oil), a vegetable oil (e.g. soybean oil, linseed oil, colza oil, corn oil or castor oil), a synthetic oil such as an aromatic hydrocarbon (alkylbenzene, alkylnaphthalene, alkylbiphenyl, alkyldiarylethylene, etc.), a silicone oil, an ether-oxide, an organic ester, and an aliphatic hydrocarbon.

### The Electrically Insulating Layer

The electrically insulating layer of the cable of the invention is a noncrosslinked layer, or in other words a thermoplastic layer.

In the invention, the expression “noncrosslinked layer” or “thermoplastic layer” signifies a layer whose gel content according to standard ASTM D2765-01 (extraction with xylene) is at most about 30%, preferably at most about 20%, especially preferably at most about 10%, more especially preferably at most 5%, and even more especially preferably 0%.

In a particular embodiment, the electrically insulating layer, preferably noncrosslinked, has a tensile strength (TS) of at least 8.5 MPa, preferably at least about 10 MPa, and especially preferably at least about 15 MPa, before aging (according to standard CEI 20-86).

In a particular embodiment, the electrically insulating layer, preferably noncrosslinked, has an elongation at break (EB) of at least about 250%, preferably at least about 300%, and especially preferably at least about 350%, before aging (according to standard CEI 20-86).

In a particular embodiment, the electrically insulating layer, preferably noncrosslinked, has a tensile strength (TS) of at least 8.5 MPa, preferably at least about 10 MPa, and especially preferably at least about MPa, after aging (according to standard CEI 20-86).

In a particular embodiment, the electrically insulating layer, preferably noncrosslinked, has an elongation at break (EB) of at least about 250%, preferably at least about 300%, and especially preferably at least about 350%, after aging (according to standard CEI 20-86).

The tensile strength (TS) and the elongation at break (EB) (before or after aging) may be determined according to standard NF EN 60811-1-1, in particular using apparatus marketed under the reference 3345 by the company Instron.

Aging is generally carried out at 135° C. for 240 hours (or 10 days).

The electrically insulating layer of the cable of the invention is preferably a recyclable layer.

The electrically insulating layer of the invention may be an extruded layer, in particular produced by methods familiar to a person skilled in the art.

The electrically insulating layer has a variable thickness depending on the type of cable envisaged. In particular, when the cable according to the invention is a low-voltage cable, the thickness of the electrically insulating layer is generally from about 1 to 2 mm. The aforementioned thicknesses depend on the size of the elongated electrically conducting element.

In the present invention, “electrically insulating layer” means a layer whose electrical conductivity may be of at most 1.10⁻⁸ S/m (siemens per meter), preferably at most 1.10⁻⁹ S/m, and especially preferably at most 1.10⁻¹⁰ S/m, measured at about 25° C. with direct current.

The electrically insulating layer of the invention may comprise at least the homophase propylene polymer, at least the homophase ethylene polymer, optionally the heterophase propylene polymer, and optionally the dielectric liquid, the aforementioned ingredients being as defined in the invention.

The proportions of the various ingredients in the electrically insulating layer may be identical to those as described in the invention for these same ingredients in the polymer composition.

The cable of the invention relates more particularly to the field of electric cables operating in direct current (DC) or alternating current (AC).

### The Cable

Preferably, the electrically insulating layer of the invention surrounds the elongated electrically conducting element.

The elongated electrically conducting element is preferably positioned at the center of the cable.

The elongated electrically conducting element may be a solid conductor such as for example a metal wire or a stranded conductor such as a plurality of metal wires, whether or not twisted.

The elongated electrically conducting element may be of aluminum, aluminum alloy, copper, copper alloy, or a combination thereof.

The cable may further comprise an outer protective sheath surrounding the electrically insulating layer.

The outer protective sheath may be in direct physical contact with the electrically insulating layer.

The outer protective sheath may be an electrically insulating sheath.

According to an especially preferred embodiment of the invention, the electrically insulating layer is directly in physical contact with the elongated electrically conducting element.

Advantageously, the cable of the invention is a low-voltage cable. In other words, it does not comprise semiconducting layer(s).

### BRIEF DESCRIPTION OF THE DRAWINGS

FIG. 1 shows a cable according to the invention.

For clarity, only the elements essential for understanding the invention are shown schematically, without respecting scale.

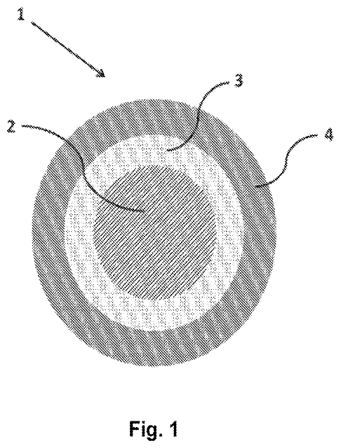

In FIG. 1, the low-voltage electric cable 1 according to the invention, illustrated in FIG. 1, comprises an elongated central electrically conducting element 2, in particular made of copper or aluminum. The electric cable 1 further comprises an electrically insulating layer 3, and optionally an outer protective sheath 4.

The electrically insulating layer 3 is a noncrosslinked extruded layer, obtained from the polymer composition as defined in the invention.

The presence of the outer protective sheath 4 is preferred, but not essential, this cable structure as such being familiar to a person skilled in the art.

### EXAMPLE

### Polymer Composition

A layer according to the invention, i.e. obtained from a polymer composition comprising
at least 50 wt % of a homophase propylene polymer relative to the total weight of said polymer composition,
at least one homophase ethylene polymer having an elastic modulus strictly greater than 300 MPa,
said propylene polymer being present in the polymer composition in an amount by weight strictly greater than that of the homophase ethylene polymer, relative to the total weight of said polymer composition, and
the polymer composition comprising at most 20 wt % of a heterophase propylene polymer, relative to the total weight of said polymer composition.

Table 1 below summarizes the amounts of the compounds present in the polymer composition according to the invention, which are expressed in percentages by weight, relative to the total weight of the polymer composition.

TABLE 1

| Ingredients of the polymer | Invention |
|---|---|
| composition | composition I1 |
| Random propylene copolymer | 64.80 |
| Linear low-density polyethylene | 34.90 |
| Antioxidant | 0.30 |

The origin of the compounds in Table 1 is as follows:
random propylene copolymer marketed by the company Total Petrochemicals under the reference PPR 3221;
linear low-density polyethylene marketed by the company Versalis under the reference Flexirene CL 10; and
antioxidant marketed by the company Ciba under the reference Irganox® B 225 comprising an equimolar mixture of Irgafos® 168 and Irganox® 1010.

### Preparation of the Noncrosslinked Layer

The following constituents are mixed in a container: random propylene copolymer, linear low-density polyethylene of the polymer composition referenced in Table 1. Then the resultant mixture is mixed using a twin screw extruder (“Berstorff twin screw extruder”) at a temperature from about 160 to 180° C., then melted at about 200° C. (screw speed: 80 rev/min).

The resultant homogenized and melted mixture is then formed into granules.

The granules were then pressed hot to form a layer in the form of a plate.

The polymer composition was thus prepared in the form of a layer with a thickness of 1 mm for evaluation of its mechanical and electrical properties.

The tests for tensile strength (TS) and elongation at break (EB) were carried out according to standard NF EN 60811-1-1, using apparatus marketed under the reference 3345 by the company Instron.

The results corresponding to each of these tests are reported in Table 2 below:

TABLE 2

| | Layer obtained from the |
|---|---|
| Properties | invention composition I1 |
| TS (MPa) | 39.3 |
| EB (%) | 926 |
| TS after aging (MPa) | 32.7 |
| EB after aging (%) | 824 |
| EB at −15° C. (%) | 285 |
| EB at −30° C. (%) | 73 |
| Breakdown strength (kV/mm) | 44 |
| Resistivity at 90° C. (MΩ · km) | 3.67 |

These results all show that the combination of the polymers as defined in the invention makes it possible to obtain a layer having good thermomechanical and electrical properties.

1. An electric cable comprising:
at least one elongated electrically conducting element and at least one electrically insulating layer obtained from a polymer composition, wherein the polymer composition comprises:
at least 50 wt % of a homophase propylene polymer relative to the total weight of polymers in said polymer composition,
at least one homophase ethylene polymer having an elastic modulus strictly greater than 300 MPa,
said propylene polymer representing a proportion by weight strictly greater than that of the homophase ethylene polymer, relative to the total weight of polymers in said polymer composition, and
the polymer composition comprising at most 10 wt % of a heterophase propylene polymer, relative to the total weight of polymers in said polymer composition.

2. The electric cable as claimed in claim 1, wherein the homophase propylene polymer is a copolymer of propylene and ethylene.

3. The electric cable as claimed in claim 1, wherein the homophase propylene polymer represents from 55 to 90 wt %, relative to the total weight of polymers in the polymer composition.

4. The electric cable as claimed in claim 1, wherein the ethylene polymer has an elastic modulus of at least 325 MPa.

5. The electric cable as claimed in claim 1, wherein the homophase ethylene polymer represents from 10 to 45 wt % relative to the total weight of polymers in the polymer composition.

6. The electric cable as claimed in claim 1, wherein the ethylene polymer has a density of at most 0.936 g/cm³.

7. The electric cable as claimed in claim 1, wherein the homophase propylene polymer, the homophase ethylene polymer, and the heterophase propylene polymer when it is present, represent at least 80 wt %, relative to the total weight of polymers in the polymer composition.

8. The electric cable as claimed in claim 1, wherein the polymer composition comprises from 0 to 8 wt % of a heterophase propylene polymer relative to the total weight of polymers in the polymer composition.

9. The electric cable as claimed in claim 1, wherein the heterophase propylene polymer is a heterophase propylene copolymer.

10. The electric cable as claimed in claim 1, wherein the heterophase propylene polymer comprises a thermoplastic phase of the propylene type and a thermoplastic elastomer phase of the type of copolymer of ethylene and an α₂ olefin.

11. The electric cable as claimed in claim 10, wherein the thermoplastic elastomer phase of the heterophase propylene copolymer represents at least about 20 wt %, and preferably at least about 45 wt %, relative to the total weight of the heterophase propylene copolymer.

12. The electric cable as claimed in claim 1, wherein the polymer composition does not comprise polar polymer(s).

13. The electric cable as claimed in claim, 1 wherein the polymer composition further comprises at least one antioxidant and/or at least one metal deactivator.

14. The electric cable as claimed in claim 1, wherein the electrically insulating layer is a noncrosslinked layer.

15. The electric cable as claimed in claim 1, wherein the electrically insulating layer is directly in physical contact with the elongated electrically conducting element.

16. The electric cable as claimed in claim 1, wherein said electric cable further comprises an outer protective sheath surrounding the electrically insulating layer.
